(19) United States
(12) Patent Application Publication
(10) Pub. No.: US 2008/0078097 A1
(43) Pub. Date: Apr. 3, 2008

(54) FLOOR DRYING DEVICE

(76) Inventor: Joshua M. Lopez, Los Angeles, CA (US)

Correspondence Address: MARC E. HANKIN, ESQ., 11414 THURSTON CIRCLE, LOS ANGELES, CA, 90049, US

(21) Appl. No.: 11/692,888

(22) Filed: Mar. 28, 2007

Related U.S. Application Data
(60) Provisional application No. 60/847,894, filed on Sep. 29, 2006.
(60) Provisional application No. 60/847,848, filed on Sep. 29, 2006.

(51) Int. Cl. F26B 19/00

(52) U.S. Cl. 34/88; 34/90; 40/606.03

(57) ABSTRACT

Various embodiments of this invention disclose a floor drying device that features a fan and in compatible with standard caution signage. In various embodiments of the invention, the device attaches to standard caution signs in order to dry the floor as the sign indicates caution to passersby. In various embodiments of the invention, the device is configured to mount a standard caution sign over the device, in order to indicate to passersby of the hazard as the device dries the floor.

### RELATED APPLICATIONS

This application claims the benefit of U.S. Provisional Application No. 60/847,894, filed on Sep. 29, 2006, and U.S. Provisional Application No. 60/847,848, filed on Sep. 29, 2006.

### FIELD OF INVENTION

Various embodiments of this invention relate, generally, to devices for drying floors after cleaning, more particularly to electrically powered devices for drying floors that are compatible to mount to commercially available caution signs.

### BACKGROUND

In the janitorial services field, floors are commonly cleaned and mopped using a variety of water based cleansers. When cleaning and mopping slippery surfaces, such as linoleum, ceramic tile, or marble, until the cleaning solution and water dries, a potential slip hazard is created for visitors or passersby. Thus, janitors commonly either restrict access to the wet area or place caution signs in order to warn people of the slipping hazard. Restricting access, however, is highly undesirable because, in heavily trafficked areas, the reduced access leads to congestion of the floor space. Meanwhile, the effectiveness of warning signs is limited because they do not alleviate the hazard and serve only to warn those persons that take the time to read them.

U.S. Pat. No. 6,338,213 to Young et al. discloses one caution sign that is directed towards alleviating some of the concerns presented by wet floors. Young's patent discloses a non-tippable pop-up caution sign that improves upon common A-frame caution signs by featuring a removable extension member that is extended in order to indicate caution to passersby. Despite the extension member and additional caution signals provided by Young's disclosure, however, the invention is subject to the same shortcomings as that of the common floor-mounted commercial warning signs.

Another device, directed towards alleviating some of the concerns created by wet floors is disclosed by U.S. Pat. No. 5,208,940 to London. London's patent discloses a floor drying system that features a signal system to alert passersby to the hazards created by the wet floors. London's device features a vacuum hose, which may be handled in order to vacuum moisture from floors. The device further features a fan mounted at the underside of the device that is configured in order to provide suction to the vacuum and direct exhaust air downwards towards the floor. In this manner, the exhaust air is used in order to dry the floors after they are cleaned. While London improves on common systems in the art, it is directed towards a complicated floor cleaning apparatus and is not compatible with the common A-frame caution signs used in the art.

Another such device is disclosed by U.S. Patent Application No. 2003/0115783 by Woosley. Woosley's application discloses a portable wet floor drier and warning sign that includes a power driven fan mounted on the lower end of the sign in order to direct air towards the floor. Woosley's device also discloses the use of an integral heater in order to warm air that is blown onto the floor. While Woosley's device contemplates the use of hinged panels in order that the device may be folded for easy storage, Woosley fails to disclose a device that is compatible with the common caution signs used in the art.

Therefore, there remains a long felt need in the art for a floor drying device that is compatible with standard floor caution signs such that the device may be used to dry wet floors while alerting passersby of the hazard of wet floors.

### SUMMARY OF THE INVENTION

Various embodiments of the invention are directed towards overcoming the above shortcomings by disclosing a floor drying device that is compatible with standard floor caution signs.

Various embodiments of the invention feature a fan that is configured to direct air across the floor, either downwards towards the floor, or alternatively, horizontally across the floor. In various embodiments of the invention, the fan features a housing that is configured to allow the passage of air from the fan while maintaining the safety of the unit by protecting the user's fingers from the fan by covering the fan blades with a fan shroud. The fan further features a motor housing, which mounts the motor and other electronic components of the device.

In various embodiments of the invention, the device may be powered by plugging the device into an outlet or through battery power. In various embodiments of the invention, the power source for the device includes a rechargeable battery source that can be charged through the power supplied by the power outlet.

In various embodiments of the invention, the device further features a battery housing. The battery housing is configured to mount the batteries in embodiments of the invention that rely upon battery power. In various embodiments of the invention, the battery housing houses a rechargeable battery pack that is charged through a power cord that supplies power from a wall outlet.

In various embodiments of the invention, the device comprises a fan system that mounts to the bottom of existing standard floor caution signs. The standard floor caution signs that remain within the contemplation of this invention include standard A-frame signs, triangular signs, square signs, and other such signs known in the art. In various embodiments of the invention, the device comprises a frame that mounts between the fan hinged A-members of the common A-frame shaped sign. The device may mount to the A-frame sign through hooks, screws, fasteners, or any of the various other mounting means known in the art. When mounted to the sign, the device is configured such that the air is blown across the floor, either downwards towards the floor, or alternatively, horizontally across the floor. In this manner, as the sign cautions passersby against the hazards of the slippery floor, it also serves to dry the wet floor.

It should be noted that the embodiments of the invention discussed in this specification represent a marked improvement over the related art patents discussed in the Background Section. Unlike Woosley and London's devices the various embodiments are compatible with existing caution signs. Thus, unlike the prior disclosures, the device may be mounted to and used along with existing standard janitorial equipment.

In various embodiments of the invention, the fan serves as a mounting surface for common caution signs. In these embodiments of the invention, the fan attaches a plurality of legs or casters, which allow the fan to be suspended above the floor. The fan, meanwhile, attaches a frame that is used to suspend common floor signs.

In various embodiments of the invention, rather than mounting floor signs, the invention is configured to mount standard mop buckets. In these embodiments of the invention, the mop bucket may be placed over the invention in order that the invention direct air to the floor while suspending the mop bucket. Further, in embodiments of the invention that features casters, the invention may serve to allow easy transport of the mop bucket.

In various embodiments of the invention, the frame attaches floor signs through a plurality of flat surfaces that attach the sign. In various embodiments of the invention, the flat surfaces further feature clips that allow the sign to be removably attached to the frame. In this manner, the frame mounts both the sign and suspends the fan above the floor, such that the fan may blow air over the floor, either downward or horizontally.

In mounting both a fan and a sign, these embodiments of the invention improve upon the prior art systems by remaining compatible with existing common caution signs. Thus, the device may be used with a plurality of existing sign types. Further, in embodiments that attach casters to the frame, the device may be easily moved throughout an area of floor in order to dry the floor.

It further remains within the contemplation of the invention to be used with varying types of power sources, casters, fans, fan blades, signs, and other such variations known in the art, without departing from the principles of the invention.

### BRIEF DESCRIPTION OF THE DRAWINGS

FIG. 1 is an illustration from a side of one embodiment of the invention.

FIG. 2 is an illustration from a front view of one embodiment of the invention.

FIG. 3 is an illustration from a side of one embodiment of the invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope the invention.

In the following description, certain terminology is used to describe certain features of one or more embodiments of the invention. For instance, “fan” refers to any of the various electro-mechanical devices used for moving air including but not limited to axial fans, centrifugal fans, radial fans, cross flow fans, tangential fans, or other such fans known in the art; “sign” refers to any A-frame, triangular, square, or other such floor mounted sign made from plastic, metal, or other such materials and used in indicating caution and hazard to passers by.

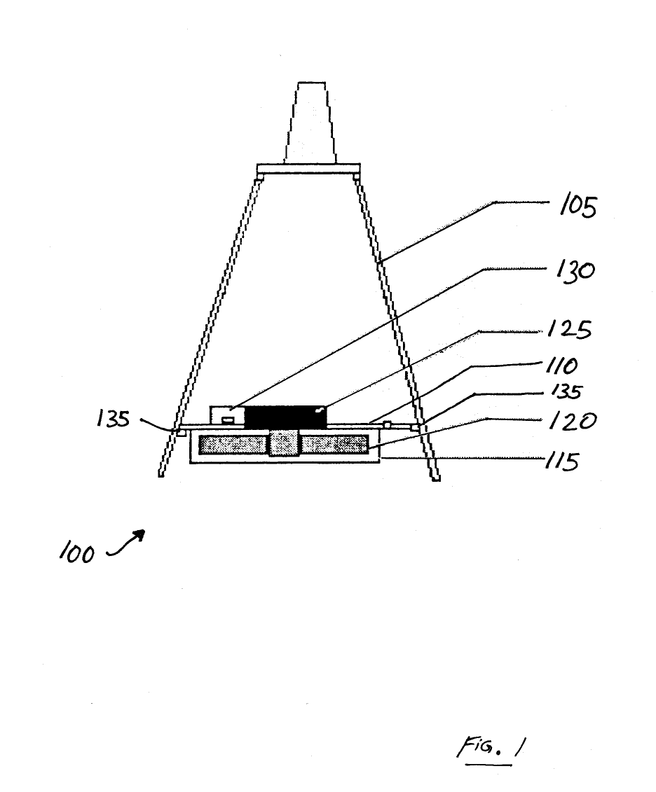

FIG. 1 is an illustration from a side of one embodiment of the invention. A floor drying device 100 is illustrated along with its constituent parts including the A-frame 105, which features the caution sign, the fan frame 110, the fan shroud 115, the fan blade 120, the fan motor housing 125, the battery housing 130, and the fan frame mounts 135. The A-frame in various embodiments of the invention is a standard caution sign that is commonly used in commercial janitorial services. The fan frame 110 attaches to the A-frame 105 by the fan frame mounts 135, which may feature hooks, fasteners, clips or other such devices known in the art for mounting the fan frame 110 to the A-frame 105. In addition to attaching the fan frame 110 to the A-frame 105, the fan frame mounts 135 also serve to mount the parts of the fan, including the fan shroud 115, the fan blade 120, and the fan motor housing 125. The fan shroud 115 serves to protect the user from the moving parts of the fan mechanism. In this manner, these embodiments of the invention represent a marked improvement on the prior art devices because it allows the drying fan to be mounted to standard, common commercial caution signs.

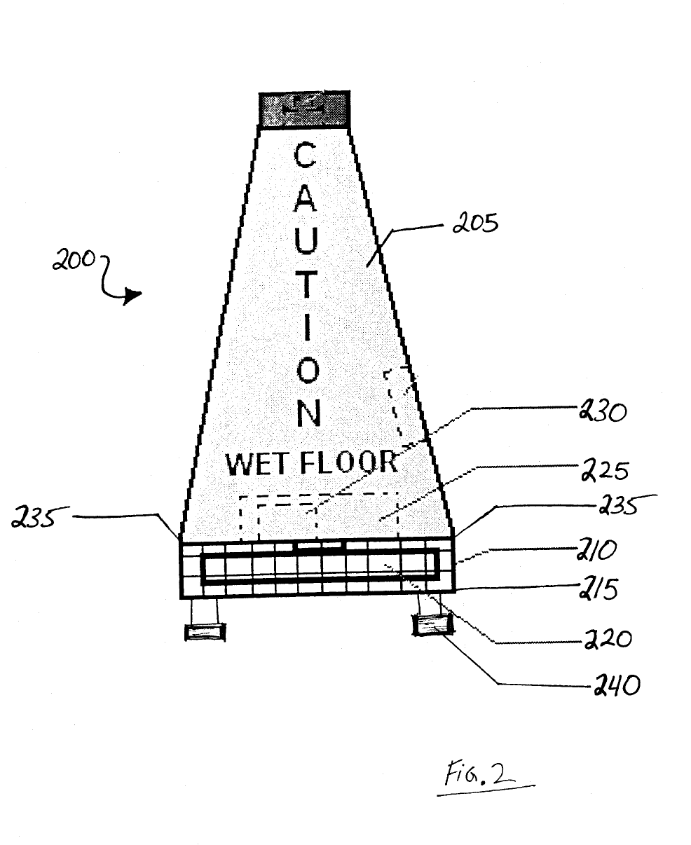

FIG. 2 is an illustration from a front view of one embodiment of the invention. A floor drying device 200 is illustrated along with its constituent parts including the A-frame sign 205, the fan frame 210, the fan shroud 215, the fan blades 220, the fan motor housing 225, the battery housing 230, the A-frame mounting 235, and the casters 240. In various embodiments of the invention, the fan frame 210 is a modular device that may be used to mount any of the various A-frame signs 205 known in the art atop the fan. The fan frame 210 features a plurality of A-frame mountings 235, which allow the A-frame signs 205 to be attached to the fan frame 210 via any of the various clips known in the art. The casters 240, meanwhile, allow the fan frame 210 to be easily moved around the floor. In this manner, the device remains compatible with any of the various A-frame signs 205 commonly used in the art.

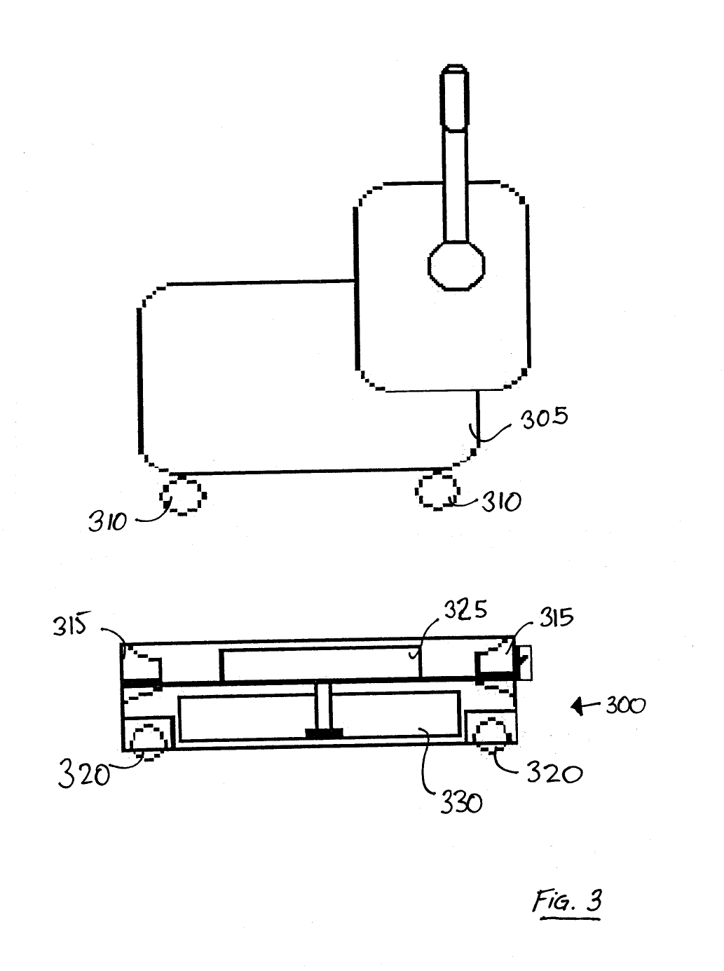

FIG. 3 is an illustration from a side of one embodiment of the invention. A floor drying device 300 is illustrated along with a typical mop bucket 305. The mop bucket 305 features a plurality of bucket casters 310, which attach to a plurality of corresponding depressions 315 that operate to attach the mop bucket 305 to the floor drying device 300. The floor drying device 300 further features a plurality of casters 320, which suspend the drying device 300 above the floor and allow the drying device 300 and mop bucket 305 to slide along the floor. In various embodiments of the invention, the floor drying device further features a fan blade housing 330 and a fan motor housing 325.

What is claimed is:

1. A modular floor drying device that is compatible with standard caution signage, comprising:
a fan frame, said fan frame being configured to mount electronic fan components, mechanical fan components, and to attach to a caution sign,
said electronic fan components comprising a power source, a fan motor and said mechanical fan components comprising a fan blade and a fan blade protective shroud,
said fan blade being configured to force air across the floor when said modular floor drying device is attached to said caution sign.

2. A modular floor drying device that is compatible with standard caution signage according to claim 1, wherein said power source comprises a power cord that is configured to be connected to a wall power outlet.

3. A modular floor drying device that is compatible with standard caution signage according to claim 1, wherein said power source comprises a battery power source.

4. A modular floor drying device that is compatible with standard caution signage according to claim 3, wherein said battery power source comprises a rechargeable battery that is charged by a power cord that is configured to be connected to a wall power outlet.

5. A modular floor drying device that is compatible with standard caution signage according to claim 1, wherein said fan frame is configured to attach to a standard A-frame caution sign such that said standard A-frame caution sign stands on the floor and suspends said modular floor drying device above the floor.

6. A modular floor drying device that is compatible with standard caution signage according to claim 1, wherein said fan frame features a plurality of downward facing vertical extensions that support said fan frame above the floor and said fan frame further features a mounting surface, said mounting surface being configured to support a standard A-frame caution sign.

7. A modular floor drying device that is compatible with standard caution signage according to claim 6, wherein said vertical extensions further feature a plurality of casters.

8. A modular floor drying device that is compatible with standard caution signage according to claim 6, wherein said fan frame attaches to said A-frame caution sign by one of the following attachments systems: hooks, fasteners, clips, or screws.

9. A modular floor drying device that is compatible with standard caution signage according to claim 6, wherein said mechanical fan components comprise a fan selected from the following fan types: axial fans, centrifugal fans, radial fans, cross flow fans, or tangential fans.

10. A modular floor drying kit that is compatible with standard caution signage, comprising:
a fan frame, said fan frame being configured to mount electronic fan components, mechanical fan components, and to attach to a standard A-frame caution sign,
said electronic fan components comprising a power source, a fan motor and said mechanical fan components comprising a fan blade and a fan blade protective shroud,
said fan blade being configured to force air across the floor when said modular floor drying kit is attached to said caution sign, and
said caution sign being configured such when said fan frame is mounted to said caution sign, said fan frame is suspended above the floor.

11. A modular floor drying kit that is compatible with standard caution signage according to claim 10, wherein said power source comprises a power cord that is configured to be connected to a wall power outlet.

12. A modular floor drying kit that is compatible with standard caution signage according to claim 10, wherein said power source comprises a battery power source.

13. A modular floor drying kit that is compatible with standard caution signage according to claim 12, wherein said battery power source comprises a rechargeable battery that is charged by a power cord that is configured to be connected to a wall power outlet.

14. A modular floor drying kit that is compatible with standard caution signage according to claim 10, wherein said mechanical fan components comprise a fan selected from the following fan types: axial fans, centrifugal fans, radial fans, cross flow fans, or tangential fans.

15. A modular floor drying kit that is compatible with standard caution signage, comprising:
a fan frame, said fan frame being configured to mount electronic fan components, mechanical fan components, to attach to a standard caution sign, and featuring a plurality of downward vertical extensions,
said downward vertical extensions being configured to suspend said fan frame over the floor,
said electronic fan components comprising a power source, a fan motor and said mechanical fan components comprising a fan blade and a fan blade protective shroud,
said fan blade being configured to force air across the floor when said modular floor drying kit is attached to said caution sign, and
said fan frame being configured such that said caution sign attaches atop said fan frame.

16. A modular floor drying kit that is compatible with standard caution signage according to claim 15, wherein said downward vertical extensions further feature a plurality of casters.

17. A modular floor drying kit that is compatible with standard caution signage according to claim 15, wherein said fan frame attaches to said caution sign by one of the following attachments systems: hooks, fasteners, clips, or screws.

18. A modular floor drying kit that is compatible with standard caution signage according to claim 15, wherein said mechanical fan components comprise a fan selected from the following fan types: axial fans, centrifugal fans, radial fans, cross flow fans, or tangential fans.

19. A modular floor drying device that is compatible with standard mop buckets, comprising:
a fan frame, said fan frame being configured to mount electronic fan components, mechanical fan components, and to attach to a mop bucket,
said electronic fan components comprising a power source, a fan motor and said mechanical fan components comprising a fan blade and a fan blade protective shroud,
said fan blade being configured to force air across the floor when said modular floor drying device is attached to said mop bucket.

20. A modular floor drying device that is compatible with standard mop buckets according to claim 19, wherein said power source comprises a power cord that is configured to be connected to a wall power outlet.

21. A modular floor drying device that is compatible with standard mop buckets according to claim 19, wherein said power source comprises a battery power source.

22. A modular floor drying device that is compatible with standard mop buckets according to claim 21, wherein said battery power source comprises a rechargeable battery that is charged by a power cord that is configured to be connected to a wall power outlet.

23. A modular floor drying device that is compatible with standard mop buckets according to claim 21, wherein said fan frame features a plurality of downward facing vertical extensions that support said fan frame above the floor and said fan frame further features a mounting surface, said mounting surface being configured to support a standard mop bucket.

24. A modular floor drying device that is compatible with standard caution mop buckets according to claim 23, wherein said vertical extensions further feature a plurality of casters.

25. A modular floor drying device that is compatible with standard mop buckets according to claim 19, wherein said mechanical fan components comprise a fan selected from the following fan types: axial fans, centrifugal fans, radial fans, cross flow fans, or tangential fans.
